(19) United States
(12) Patent Application Publication
(10) Pub. No.: US 2026/0241382 A1
(43) Pub. Date: Aug. 20, 2026

(54) MICROFLUIDIC CHIP AND METHOD FOR GENERATING AND SORTING HIGH-FREQUENCY MONODISPERSE MICRODROPLETS

(71) Applicants: HEKAT, PESSAC (FR); CENTRE NATIONAL DE LA RECHERCHE SCIENTIFIQUE, PARIS (FR); UNIVERSITE DE BORDEAUX, BORDEAUX (FR)

(72) Inventors: Mathias GIRAULT, TALENCE (FR); Sophie BOURZEIX, BORDEAUX (FR)

(21) Appl. No.: 19/165,288

(22) PCT Filed: Mar. 28, 2024
(86) PCT No.: PCT/EP2024/058657

§ 371 Date: Sep. 15, 2025

(30) Foreign Application Priority Data
Mar. 30, 2023 (FR) 2303128

(51) Int. Cl. B01L 3/00

(52) U.S. Cl. CPC B01L 3/502784; B01L 2200/027; B01L 2200/0636; B01L 2200/0673; B01L 2300/0645; B01L 2400/0487

(57) ABSTRACT

The present invention relates to a microfluidic chip (30) for generating and sorting monodisperse microdroplets (32).

According to the invention, the microfluidic chip (30) comprises a junction zone (7), an expansion zone (8) downstream of the junction zone (7), and a sorting zone (18) arranged downstream of the expansion zone (8), the junction zone (7) comprising a central nozzle (21) for injecting central fluid (3), two lateral nozzles (22, 23) for injecting sheath fluid (1), the central nozzle (21) having a narrowest width x of between 2 and 10 micrometres, each of the two lateral nozzles (22, 23) having a narrowest width x1 of between 3 and 10 micrometres, a fluidic microchannel (24) having a width y of between 2 and 7 micrometres and a length z of between 2 and 10 micrometres, and an expansion zone (8) having a widest width u of between 20 and 75 micrometres and a length V of between 100 and 600 micrometres, the junction zone (7), the fluidic microchannel (24) and the expansion zone (8) having a depth h of between 2 and 10 μm.

### TECHNICAL FIELD OF THE INVENTION

The present invention relates to the technical field of microfluidic chips and methods for high-frequency generation and sorting of monodisperse and ordered microdroplets having a volume of between 1 femtolitre (fL) and 200 fL.

More particularly, it relates to a microfluidic chip for generating monodisperse and ordered microdroplets with a determined volume, at a high frequency, i.e. a frequency higher than or equal to 1 kilohertz (kHz), preferably higher than or equal to 10 kHz, for example of 60 kHz. It also relates to a microfluidic chip for actively generating and sorting one by one each microdroplet of the train of monodisperse microdroplets, wherein the sorting can be performed at high-frequency, i.e. at a frequency higher than 10 kHz, for example of 60 kHz.

### STATE OF THE ART

In the above domain, it is known to use flow cytometers to detect, count and identify cells or particles of micrometric dimensions suspended in a flowing fluid by making them scroll, one by one and at high speed, in the beam of one or more lasers. Some sorter-cytometers further enable to sort these particles by implementation of sorting methods based on various techniques. Advances in microscopy and biology have made it possible to focus on ever-smaller objects, in particular nano-objects smaller than 100 nm. However, traditional flow cytometers generate drops of diameter of between 30 micrometres (μm) and 300 μm, i.e. volumes of between 10 picolitres and 10 nanolitres and enable to sort only objects greater than several hundreds of nanometres.

For objects smaller than 100 nm, cytometers are currently limited by their detection capacity. Moreover, as regards the nano-object sorting operation, the fluid volumes generally used by the known cell sorters and the size of the drops serving to encapsulate the objects to be sorted are not compatible with the sorting of nano-sized objects.

Indeed, studies on nanometric objects (of between a few nanometres and a few tens or even a few hundreds of nanometres) require that these objects can be analysed one by one. Given the very small size of these objects, it proved interesting from a practical point of view to encapsulate them in fluid drops, these drops being then easier to handle, analyse and sort. When drops are extracted from a liquid containing a certain concentration of these particles, Poisson's law can be used to calculate the probability that a given drop contains N particles, where N is a positive integer or zero. This law is written:

$$P ( N ) = \frac{{e}^{λ} \cdot {λ}^{N}}{N !}$$

wherein P(N) is the probability that a drop contains N particles, and λ is the average number of particles per drop, for a drop of given volume and a given particle volume concentration.

In particular, if it is searched to encapsulate individual objects, this law enables to determine, for given volume dilution or concentration, the optimum drop volume for which the number of drops containing more than one particle is minimized, while maximizing the number of non-empty drops.

The typical liquid concentrations containing organic nanoparticles are generally between 10⁹ and 10¹⁰ particles per ml. According to the above calculations, spherical drops of 30 μm to 300 μm in diameter (volume between 10 picolitres and 10 nanolitres) are adapted to samples having a concentration between 10³ and 10⁶ particles per ml, which is quite insufficient for usual samples of biological nanometric particles. To reach such concentrations, it would be necessary to excessively dilute the biological samples (for example, a typical 1-ml sample should be diluted to a minimum volume of 1 litre, or even 1000 litres). On the contrary, biologists want to concentrate such samples. For an average concentration of 5.10⁹ particles per ml, Poisson's law enables to determine the probability that a given drop contains 0, 1 or 2 particles as a function of the drop volume. For the number of drops containing only one particle is higher than or equal to 10%, while keeping the number of drops containing more than one particle below or equal to 1%, the drop volume is between 30 fL and 40 fL. At this concentration of 5.10⁹ particles per ml, for drop volumes of less than 30 fL, the percentage of empty drops, i.e. with no particles at all, is over 90%, resulting in longer analysis times, as all drops have to be analysed even though most are empty. Conversely, for drop volumes of more than 40 fL, the percentage of drops containing more than one particle is higher than 1%, which is a significant source of error, thus reducing the analysis and sorting quality.

The sample fluid microdroplets (i.e. the central fluid) may be generated by emulsification in a sample fluid, the sample fluid and the sheath fluid being immiscible with each other, for example based on water in oil or oil in water. The microdroplets may be generated by flow focusing in a microchannel of a microfluidic chip, so that the sample fluid breaks up into microdroplets dispersed in the sheath fluid. The microdroplet diameter or volume generally depends on the size of the microchannels of the microfluidic chip and also varies as a function of many environment parameters, such as variations in the pressure or flow rate of injected fluids. However, hydrodynamic phenomena on a microscopic scale are complex to predict and model. In a same microfluidic device, the generation of drops is very dependent on injection conditions. Microdroplets volume variations are observed over time, and are difficult to control.

In the present document, the term “monodisperse microdroplets” means microdroplets having all a same volume +/−20% for example. In other words, the volume of the monodisperse microdroplets is uniform. The monodisperse microdroplets are generally in suspension in a flow of encapsulation fluid or sheath fluid.

Microfluidic devices are known which enable to generate monodisperse microdroplets having a volume of the order of 10 pL, i.e. a diameter of more than 30 μm, capable of operating at a generation frequency of less than 5 kHz in general, and sometimes up to 30 kHz. However, the volume of these microdroplets is too high with respect to nano-objects that are to be analysed individually.

The publication “Shui, L., van den Berg, A. & Eijkel, J. C. T. Scalable attoliter monodisperse droplet formation using multiphase nano-microfluidics. Microfluid Nanofluid 11, 87-92 (2011). https://doi.org/10.1007/s10404-011-0776-7” describes a device comprising a nanochannel-microchannel interface making it possible to generate monodisperse drops having a diameter of between 0.4 and 3.5 μm (with a minimal volume minimum of 30 aL). However, the frequency of generation of these microdroplets is limited to a few hundreds of hertz. The drops generated are stored in a reservoir and form a compact 2D stack.

The publication Shim JU, Ranasinghe RT, Smith CA, Ibrahim SM, Hollfelder F, Huck WT, Klenerman D, Abell C. Ultrarapid generation of femtoliter microfluidic droplets for single-molecule-counting immunoassays. ACS Nano. 2013 Jul. 23; 7(7):5955-64. doi: 10.1021/nn401661d. Epub 2013 Jul. 8. PMID: 23805985, describes a device for generating drops having a volume of 32 fL. However, this device does not allow sorting individual drops on the fly.

The microfluidic systems generally comprise a microfluidic chip for producing drops and another microfluidic drop for sorting the drops, the drops being stored in the interval between their production and sorting. Such an arrangement requires the reinjection of the drops into another chip, which is particularly complex, and significantly increases both the processing time and the risks of errors or other difficulties such as droplet melting, leakage of liquid from the droplets into the sheath liquid, handling difficulties and the need for relatively large droplet volumes.

There exists a need for a device and a method for isolating, detecting, analysing and sorting individually objects smaller than a micrometre, for example encapsulated in microdroplets, at high speed.

For that purpose, there exists a need for a device and a method for generating monodisperse microdroplets having a determined volume of the order of the femtolitre, for example of between 1 fL and 200 fL, at a frequency of generation higher than 1 kHz, preferably higher than or equal to 10 kHz and capable of reaching several tens of kHz or one hundred of kHz, and enabling an individual analysis and/or sorting of each microdroplet, also at high rate, ideally at the same rate as the frequency of generation. There exists a need for a device and a method for generating such monodisperse microdroplets, which is stable, reproducible, insensitive to variations in environmental parameters and easy to manufacture.

Moreover, there exists a need for a device and a method for generating such monodisperse microdroplets, then individually detecting and actively sorting each microdroplet on the same fluidic chip, at high sorting rate, higher than 10 kHz and liable to reach several tens of kHz or one hundred of kHz.

### DISCLOSURE OF THE INVENTION

In this context, the present invention proposes a microfluidic chip for generating and sorting monodisperse microdroplets based on a central fluid in a sheath fluid, the central fluid and the sheath fluid being immiscible with each other.

According to the invention, the microfluidic chip comprises a central fluid injection channel, two sheath fluid injection channels and the microfluidic chip comprises a junction zone, an expansion zone downstream of the junction zone and a sorting zone arranged downstream of the expansion zone, a fluidic microchannel fluidically connecting the junction zone to the expansion zone, the sorting zone comprising a fluidic channel fluidically connected, at its inlet, to the expansion zone and, downstream, to at least two outlet channels, the junction zone comprising a central nozzle fluidically connected to the central fluid injection channel, two lateral nozzles arranged on two opposite sides of the junction zone, each of the two lateral nozzles being fluidically connected to one of the two sheath fluid injection channels, the fluidic microchannel being arranged on an opposite face of the junction zone with respect to the central nozzle, the central nozzle having a narrowest width x of between 2 and 10 micrometres, each of the two lateral nozzles having a narrowest width x1 of between 3 and 10 micrometres, the fluidic microchannel having a width y of between 2 and 7 micrometres, and a length z of between 2 and 10 micrometres, the expansion zone having a widest width u of between 20 and 75 micrometres and the expansion zone having a length V of between 100 and 600 micrometres, and in that the junction zone, the fluidic microchannel, the expansion zone and the fluidic channel of the sorting zone have a depth h of between 2 micrometres and 10 micrometres, the microfluidic chip being capable of generating, via the fluidic microchannel, monodisperse microdroplets having a determined volume of between 1 femtolitre and 200 femtolitres.

Therefore, the microfluidic chip enables to sequentially generate, one by one, monodisperse microdroplets of a central fluid in a sheath fluid at a stable production frequency of more than 10 kilohertz, for example of 60 kHz. The microdroplets have a diameter determined by the size and geometry of the central fluid and duct fluid inlet nozzles, and of the outlet nozzle (i.e. the fluidic microchannel connecting the junction zone to the expansion zone), for example a diameter of between 4 and 5 micrometres. Therefore, the microdroplets are monodisperse, i.e. all the microdroplets have the same volume and this volume is predetermined. Moreover, the so-generated monodisperse microdroplets remains ordered in a single column in the expansion zone.

Other non-limiting and advantageous features of the microfluidic according to the invention, taken individually or according to all the technically possible combinations, are the following:
the sorting zone comprises an active electrode arranged on one side of the fluidic channel and two ground electrodes arranged on either side of the fluidic channel, the two ground electrodes surrounding the active electrode in the sorting zone around the fluidic channel, the active electrode being at a minimum distance from the fluidic channel of between 5 μm and 40 μm;
the sorting zone comprises two active electrodes and two ground electrodes, the two active electrodes being arranged on two opposite sides of the fluidic channel, the two ground electrodes being arranged on two opposite sides of the fluidic channel, each of the two ground electrodes surrounding one of the two active electrodes in the sorting zone around the fluidic channel, each of the two active electrodes being at a minimum distance from the fluidic channel of between 5 μm and 40 μm;
the microfluidic chip comprises at least one lateral channel fluidically connected to the inlet of the sorting zone, the at least one lateral channel being adapted to inject a sheath fluid flow;
the microfluidic chip comprises at least one balancing microchannel fluidically connecting one of the outlet channels to another outlet channels, said at least one balancing microchannel having a depth equal to the shallow depth h;
the expansion zone has at the exit of the fluidic microchannel a reduced width r of between 5 and 15 micrometres, and the expansion zone widens downstream of the reduced width r to the widest width u;
the expansion zone is connected to the fluidic channel of the sorting zone by a fluidic channel having a depth equal to the shallow depth h and a width of about 20 μm, the width of the expansion zone narrowing downstream from the widest width u to the width of about 20 μm of the fluidic channel;
the central fluid injection channel, the two sheath fluid injection channels and the at least two outlet channels have a depth equal to the swallow depth h;
the central fluid injection channel, the two sheath fluid injection channels and the at least two outlet channels have a depth H deeper than the depth h of the junction zone, the depth H being between 6 micrometres and 20 micrometres;
the microfluidic chip comprises a device based on micro-pumps or syringe pumps adapted to inject the sheath fluid and the central fluid respectively into the microfluidic chip.

The invention also relates to a method for generating and sorting monodisperse microdroplets by means of a microfluidic chip according to the present disclosure, the method comprising the following steps:
simultaneously injecting a central fluid into the central fluid injection channel towards the junction zone of the microfluidic chip and a sheath fluid into the two sheath fluid injection channels towards the junction zone;
generating monodisperse microdroplets of central fluid within the sheath fluid in the fluidic microchannel fluidically connecting the junction zone to the expansion zone of the microfluidic chip, the microdroplets having a determined volume, of between 1 femtolitre and 200 femtolitres, and
propagating the microdroplets in an ordered manner towards the sorting zone of the microfluidic chip so as to actively and individually sort each microdroplet.

Therefore, the microfluidic chip of the present disclosure enables to perform three functions on the same chip: creating monodisperse drops with a determined volume, for between 1 fL and 200 fL, propagating the drops in an ordered manner towards a measuring and sorting zone, the drops being arranged in a single column, then measuring and deflecting the individual drops according to the measurement result. The configuration of the microfluidic chip, in particular the dimensions of the junction zone, the expansion zone and the sorting zone as well as the small distance between the microdroplet production zone and the sorting zone enable both to generate monodisperse microdroplets of small volume, between 1 fL and 200 fL, at a high frequency (e.g. several tens of kHz) and to lead in a single ordered column from the generation zone to the sorting zone, then to actively and individually sort each microdroplet, with a great efficiency and a high sorting frequency.

The present disclosure therefore presents the conditions for making a train of drops of known diameter, then propagating the drops by maintaining the alignment thereof in a single column, oriented along the sheath fluid flow direction, and at stable speed, then individually sorting the drops that arrive sequentially at the measuring and sorting zone.

Obviously, the different features, alternatives and embodiments of the invention can be associated with each other according to various combinations, insofar as they are not incompatible or exclusive with respect to each other.

### BRIEF DESCRIPTION OF THE DRAWINGS

Moreover, various other features of the invention emerge from the appended description made with reference to the drawings that illustrate non-limiting embodiments of the invention, and wherein:

FIG. 1 is a schematic view of the fluidic circuit of a microfluidic chip according to an exemplary embodiment of the present disclosure;

FIG. 2 is an enlarged view of the central part of the microfluidic chip of FIG. 1;

FIG. 3 is an enlarged view of the junction zone and of a part of the expansion zone of the microfluidic chip of FIGS. 1 to 3;

FIG. 4 is an enlarged view of the junction zone, the expansion zone and the sorting zone of the microfluidic chip of FIGS. 1 and 2, with arrows indicating the direction of the different flows;

FIG. 5 is an enlarged top view of the sorting zone of the microfluidic chip of FIGS. 1 to 4;

FIG. 6 is a cross-section AA view of the sorting zone of the microfluidic chip illustrated in FIG. 5;

FIG. 7 is an enlarged view of a junction zone and a sorting zone according to a three-outlet-channel alternative of the microfluidic chip;

FIG. 8 is an enlarged view of a microfluidic device in operation, showing the generation of a train of drops and the propagation thereof in a single column in the expansion zone.

It is to be noted that, in these figures, the structural and/or functional elements common to the different alternatives can have the same references numbers.

### DETAILED DESCRIPTION

In this document, fluid means a liquid, pure or as a mixture, or an emulsion.

The microfluidic chip 30 is generally planar in shape. The microfluidic chip 30 is made in a plate. Various materials are suitable for the plate, such as glass or also a polymer, for example polydimethylsiloxane (PDMS), having a thickness of a few millimetres, for example 5 mm. The microfluidic chip includes a cover slide 31 which is fixed, for example, by bonding or adhesion. The slide 31 is preferably transparent to allow the observation and detection of particles in suspension in a fluid. For example, the slide 31 is a microscope slide to allow observation the microfluidic chip under an optical microscope objective. A microfluidic circuit comprising in particular microfluidic channels is formed on the face of the microfluidic chip 30 placed facing the slide 31.

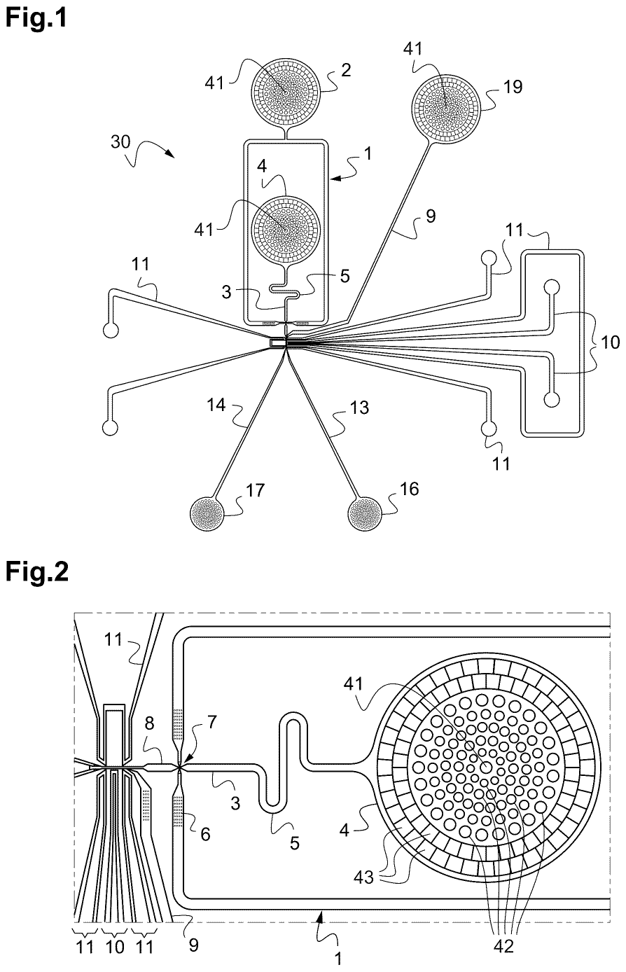

An example of microfluidic chip will now be described in detail in connection with FIGS. 1 to 8.

In FIG. 1, an example of microfluidic chip is shown in top view, for example through the slide 31. The microfluidic chip comprises a sheath fluid inlet 2 and a central fluid inlet 4. The central fluid and the sheath fluid are immiscible with each other. The central fluid or the sample fluid is for example an aqueous solution comprising in suspension micro- or nanoparticles to be analysed. The sheath fluid is a fluid that is not miscible with the central fluid, for example an oil or a mixture of oil and surfactant. The inlet 2, respectively 4, is fluidically connected to an external sheath fluid reservoir, respectively an external central fluid reservoir, the reservoirs (not shown) being equipped with micro-pumps or syringe pumps to inject the sheath fluid and respectively the central fluid into the microfluidic chip.

As an option, the inlet 2, respectively 4, includes a filter consisted for example of channels of predetermined dimensions, formed between micrometric pillars 43 arranged in concentric circles around an opening 41 through the microfluidic chip to the corresponding reservoir. Advantageously, other micrometric spacer pillars 42 are arranged around the opening 41, to maintain the depth of the spaces in which the fluid circulates between the opening 41 and the channels between the pillars 43. The micrometric pillars 42 and 43 belong to the plate of the microfluidic chip and are generally fixed at their other end to the cover slide 31. Such a filter makes it possible to filter the sheath fluid, respectively the central fluid, when they are injected into the microfluidic chip, as schematically illustrated in FIGS. 1-2.

The sheath fluid inlet 2 is connected to two sheath fluid injection channels 1 by a T-junction having one inlet and two outlets. The central fluid inlet 4 is connected to a central fluid injection channel 3. Optionally, the central fluid injection channel 3 includes a meandering portion 5, for example in the shape of an S, which allows stabilising the production of microdroplets.

The microfluidic chip comprises a junction zone 7 between the two sheath fluid injection channels 1 and the central fluid injection channel 3, illustrated in particular in FIG. 6. The two sheath fluid injection channels 1 conduct the sheath fluid towards the junction zone 7 and the central fluid injection channel 3 conducts the central fluid towards the junction zone 7.

The fluidic junction zone 7 here comprises three inlet nozzles and one outlet nozzle. More precisely, the junction zone 7 comprises a central nozzle 21 fluidically connected to the central fluid injection channel 3 and two lateral nozzles 22, 23 arranged on two opposite sides of the junction zone 7, each of the two lateral nozzles 22, 23 being fluidically connected to one of the two sheath fluid injection channels 1. The outlet nozzle of the junction zone is formed by a fluidic microchannel 24 arranged on an opposite face of the junction zone 7 with respect to the central nozzle 21. A longitudinal direction of the central nozzle 21 is denoted 28.

Advantageously, the lateral nozzles 22, 23 are arranged transversely to the longitudinal direction 28 and the fluidic microchannel 24 is in the axis of the longitudinal direction 28. The microdroplet production zone is located in the fluidic microchannel 24.

Advantageously, as illustrated in FIG. 4, the two sheath fluid injection channels 1 include filters 6 consisted of studs distributed along sheath fluid paths upstream of the junction zone 7. Optionally, an analogous filter is arranged on the central fluid injection channel 3 upstream of the junction zone 7. These filters 6 serve to retain potential unwanted particles larger than the width of the nozzles 21, 22, 23. Such unwanted particles are likely to block the nozzles 21, 22, 23 and to prevent the formation of microdroplets.

According to the present disclosure, the inlets and the outlet of the junction zone 7 have particular micrometric dimensions. In the present document, it is meant by depth of a microfluidic channel a dimension taken perpendicularly to the plane of FIGS. 1 to 5. It is meant by length of an element of the microfluidic chip, for example length of a microchannel, a dimension taken along the longitudinal axis of this element, i.e. in the flowing direction of the fluid in this microchannel, in the plane of FIGS. 1 to 5, and 7-8. It is meant by width of an element of the microfluidic chip, for example width of a microchannel, a dimension taken transversely to the longitudinal axis of this element, i.e. perpendicularly to the flowing direction of the fluid in this microchannel, in the plane of FIGS. 1 to 5, and 7-8.

The central nozzle 21 fluidically connects the central fluid injection channel 3 to the junction zone 7, by progressively reducing the width thereof. At the connection end of the junction zone 7, the central nozzle 21 has a narrowest width x of between 4 and 10 micrometres. The central nozzle 21 here has for example a length t less than or equal to 7 micrometres. Each of the two lateral nozzles 22, 23 fluidically connect one of the two sheath fluid injection channels 1 to the junction zone 7, by progressively reducing the width thereof. At the connection end of the junction zone 7, each of the two lateral nozzles 22, 23 has a narrowest width x1 of between 4 and 10 micrometres. Each of the two lateral nozzles 22, 23 here has for example a length S less than or equal to 7 micrometres. Advantageously, the two lateral nozzles 22, 23 are symmetrical with respect to the longitudinal direction 28. The fluidic microchannel 24 has a width y of between 2 and 7 micrometres and a length z of between 2 and 10 micrometres.

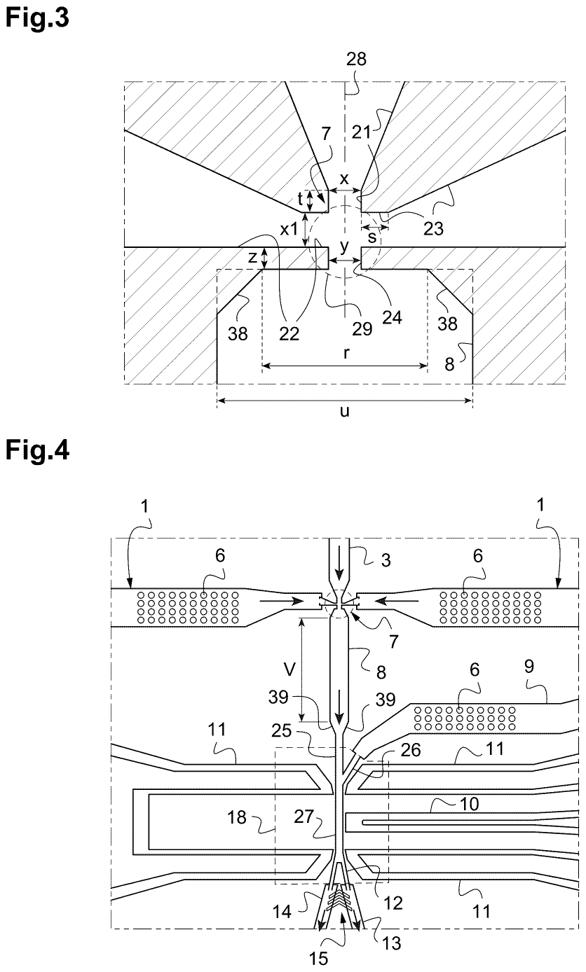

The fluidic microchannel 24 connects the outlet of the junction zone 7 to an expansion zone 8. The expansion zone 8 has a flared shape from the outlet of the fluidic microchannel 24 towards the downstream of the microfluidic chip. The expansion zone 8 has a reduced width r of between 5 and 15 micrometres at the junction with the fluidic microchannel 24. The expansion zone 8 widens downstream up to a widest width u of between 20 and 75 micrometres. The expansion zone 8 has a length v of between 100 and 600 micrometres. For example, as illustrated in FIG. 3, the expansion zone 8 comprises a chamfer 38 adapted to linearly widen the expansion zone 8 from the reduced width r to the widest width u.

Advantageously, the expansion zone 8 has a shape that narrows towards the downstream of the microfluidic chip, so as to let the microdroplets go one by one through the measuring and sorting zone, hereinafter called the sorting zone 18. A fluidic channel 25 connects the outlet of the junction zone 8 to the sorting zone 18. The fluidic channel 25 has a width of 20 μm and a length of for example 300 μm. The sorting zone 18 comprises a fluidic channel 27 forming the inlet of a junction with at least two outlet channels 13, 14. The fluidic channel 27 is connected downstream of the fluidic channel 25. At the exit of the sorting zone 18, the outlet channel 13 enables for example to keep the selected drops whereas the outlet channel 14 acts as a bin for collecting the drops not selected. The outlets channels 13, 14 have for example a width of 50 μm.

According to a particular and advantageous embodiment, the microfluidic chip has channels having a depth h, also called shallow depth, which is uniform over the whole microfluidic chip. The depth h is between 2 micrometres and 10 micrometres. Therefore, the junction zone 7, the central nozzle 21, the lateral nozzles 22, 23, the fluidic microchannel 24, the expansion zone 8, the fluidic channel 25 and the fluidic channels in the sorting zone 18 have a depth equal to depth h. The inlet 4 and the central fluid injection channel 3 have a depth equal to depth D. Likewise, the lateral channel has a depth equal to the shallow depth h.

According to another particular and advantageous embodiment, the microfluidic chip comprises two channel depths: a large depth H and a shallow depth h, such that h<H. The shallow depth h is between 2 micrometres and 10 micrometres. The deep depth H is for example between 6 micrometres and 20 micrometres. More precisely, in this case, the junction zone 7, the central nozzle 21, the lateral nozzles 22, 23, the fluidic microchannel 24 and the expansion zone 8 have a depth equal to the shallow depth h. The fluidic channel 25 and the fluidic channels in the sorting zone 18 also have a depth equal to the shallow depth h. On the contrary, the sheath fluid inlet 2 and the two sheath fluid injection channels 1 have a depth equal to the deep depth H. Similarly, at the exit of the sorting zone 18, the outlet channels 13, 14 have a depth equal to the deep depth H. Advantageously, but not necessarily, the inlet 4 and the central fluid injection channel 3 have a depth equal to the shallow depth h. As an alternative, the inlet 4 and the central fluid injection channel 3 have a depth equal to the deep depth H.

In all the embodiments, the junction zone 7 and the fluidic microchannel 24 where the microdroplets are produced have a depth h that enable to limit the microdroplet diameter and thus the volume thereof. This shallow depth h is kept from the junction zone 7 all along the drop propagation zone, in particular in the expansion zone 8, the fluidic channel 25 and the sorting zone 18. Maintaining the shallow depth h continuously throughout the path of the microdroplets from generation to sorting ensures that the droplets remain sequenced in a single column ordered in the flowing direction of the sheath fluid (see for example FIG. 8). At the exit of the fluidic microchannel 24, the microdroplets 32 generated form a single column which is carried along by the sheath fluid. Non-intuitively, although the width of the expansion zone 8 is greater than the diameter of the microdroplets 32 by about an order of magnitude, the microdroplets 32 remain ordered along a single column from the exit of the microchannel 24 to the measuring and sorting zone.

For example, a reduced depth value h of 4.5 μm contributes to the formation of microdroplets with a diameter less than or equal to the reduced depth. However, fluid movement in the zones of shallow depth is only possible by means of a strong pressure gradient between upstream and downstream. In particular in the junction zone 7 and the fluidic microchannel 24 where the microdroplets are produced, the channels are the narrowest and shallow. In an embodiment, certain channels are deeper (H=10 μm) in zones that are not critical to the production, ordered propagation or detection of microdroplets. Let's consider a fluidic channel of rectangular cross-section and a given fluid flow rate, the pressure drop is inversely proportional to the cube of the depth of the fluidic channel, for a same channel width. Therefore, a fluidic channel of depth H equals to 10 μm requires an upstream pressure ~10 times less than a channel with a reduced depth of 4.5 μm and the same width. Manufacturing, on a same microfluidic chip, of channels of deep depth H makes it possible to reduce the mechanical stresses on the microfluidic chip everywhere the depth the channel is non a parameter critical for the formation, ordered propagation or detection of the microdroplets.

In all the embodiments, the geometry of the outlet nozzle, i.e. the fluidic microchannel 24 makes it possible to generate drops in a controlled and predictable manner. The drop volume is determined by the geometry of the junction 7, and in particular the fluidic microchannel 24 forming the outlet nozzle, and does not depend on other factors, in particular it is practically independent of the pressures of the sheath fluid and the central fluid. The drop production frequency can be controlled by varying the sample fluid flow rate: by mass conservation, the input sample fluid flow rate, denoted Q, is equal to the product of the drop volume V by the production frequency f: Q=V·f. The drop volume being constant, the sample fluid flow rate variation results in a drop production frequency variation.

An important aspect of the present disclosure is linked to the configuration and operation of the expansion zone 8, which is coupled to the fluidic microchannel 24, i.e. the outlet nozzle of the junction zone 7. Experimentally, according to the present disclosure, the expansion zone 8 has a defined geometry that is neither too long nor too short, to maintain a linear sequence of drops 42. As indicated hereinabove, the expansion zone 8 has a depth equal to the shallow depth h. This expansion zone 8 makes it possible to maintain the drops 42 produced in a single column, in other word to maintain the sequencing of the drops. The configuration and operation of this expansion zone 8 are totally counter-intuitive to the one skilled in the art, and fluid theory is unable to predict why this zone is so important. On the contrary, in the prior art, most of the drop production microfluidic devices generate sets of drops in which the drops either mix or are distributed in two or more parallel rows, probably due to the phenomena of speed variation between the drops and the sheath fluid.

By way of non-limiting example, the microfluidic chip 30 is manufactured by moulding on a silicon wafer that has been structured in relief using microetching techniques. A first layer of photosensitive resin of small thickness h (e.g. thickness h equal to 4.5 μm) is deposited on an initially flat silicon wafer, for example by spin coating. This first layer is exposed by photolithography with a first mask corresponding to the microfluidic channels or elements of shallow depth h. Once this layer developed, it remains the positive shape (relief) of the future microfluidic channels or elements of shallow depth h.

In the case where certain channels have a deeper depth, a second layer of thicker resin, of thickness H (e.g. thickness H equal to 10 μm) is deposited above the first layer, in a similar way. The second layer is exposed by photolithography with a second mask corresponding to the microfluidic channels or elements of deep depth H, then developed to make appear in positive the microfluidic channels or elements of deep depth H. The second mask is aligned with respect to the first layer of resin so that the channels of shallow depth h (4.5 μm) and the channels of deep depth H (10 μm) communicate fluidically, in particular at the nozzles 22, 23.

The microstructured silicon mould is used to deposit the PDMS, for example by casting. The microfluidic chip is manufactured using photolithography and microetching techniques with critical dimensions greater than one micrometre, the shallowest depth being greater than or equal to 2 micrometres and the narrowest width being greater than or equal to 2 micrometres. Manufacturing the microfluidic chip does not require to implement nanophotolithography and nanoetching techniques, technically more demanding and much more expensive.

The operation of the so-formed microfluidic chip for generating monodisperse microdroplets will now be explained. The microfluidic chip is fixed to the slide 31 forming a side of the microfluidic channels. The central fluid is injected through the central fluid inlet 4 and circulates in the central fluid injection channel 3 towards the junction zone 7. The sheath fluid is injected through the inlet 2 and circulates in the two sheath fluid injection channels 1 towards the junction zone 7. The central fluid enters the junction zone 7 through the central nozzle 21, whereas the sheath fluid enters the junction zone 7 simultaneously through the two lateral nozzles 22, 23. The junction zone 7 thus forms a constriction of the central fluid and the sheath fluid. At crossing of the junction zone, in the microdroplet forming zone 29, the sheath fluid pinches the central fluid that splits into the microdroplets 32 in the fluidic microchannel 24. The microdroplets 32 of central fluid are thus generated one by one within the sheath fluid. At the exit of the fluidic microchannel 24, these microdroplets 32 are carried along by the sheath fluid into the expansion zone 8, while being carried in an ordered manner. More precisely, in the expansion zone 8, from the exit of the microchannel 24, the microdroplets 32 are lined up one behind the other, in a single column, oriented along the flowing direction of the sheath fluid (see FIG. 8).

Table I summarises the ranges of values for the various dimension parameters of the junction zone and the ranges of depth values for the microchannels, as well as all theses values for an exemplary embodiment with two channel depths. The combination of the values of these various parameters enables to obtain the formation of monodisperse microdroplets of determined diameter and their propagation in single ordered file.

TABLE 1

| | Min | Max | Value of |
|---|---|---|---|
| | value | value | an example |
| Parameter | (μm) | (μm) | (μm) |
| x | 2 | 10 | 5 |
| y | 2 | 7 | 5 |
| z | 2 | 10 | 7 |
| x1 | 3 | 10 | 5 |
| u | 20 | 75 | 50 |
| V | 100 | 600 | 300-400 |
| t | 0 | 7 | 5 |
| S | 0 | 7 | 5 |
| r | 5 | 15 | 7 |
| h | 2 | 10 | 4.5 |
| H | 6 | 20 | 10 |

Although these parameters are not independent from each other, it is possible to associate certain parameters with the microdroplet formation regime or with the size properties of the so-obtained microdroplets. According to the present disclosure, the narrowest width x and the length t of the central nozzle 21 allow the central nozzle to form a constriction of the central fluid. The narrowest width x1 of each of the two lateral nozzles 22, 23 is also a critical parameter for the formation of microdroplets. The range of values of the parameters x and x1 of the junction zone 7 allow droplets to be formed with a determined volume at the exit of the fluidic microchannel 24 and with a stable production of monodisperse drops. The narrowest width x1 and the length S of each of the two lateral nozzles 22, 23 allow a constriction zone of the sheath fluid to be formed. The swallow depth h, the width y and the length z of the fluidic microchannel 24 determine the diameter of the microdroplets 32. A set of parameters that are critical for the formation of microdroplets and that influence the value of the diameter of the microdroplet 32 have been determined here.

The widest width u of the expansion zone 8 determines the fluidic regime allowing the formation of microdroplets and the regular and linear flowing thereof in a single ordered column. The length V of the expansion zone 8 makes it possible to stabilise the microdroplet train by maintaining it in a single ordered column. The reduced width r of the expansion zone 8 enables an easy manufacturing by photolithography of the expansion zone 8 that extends over the widest width u and the length V and also contributes to drop flowing stabilisation.

The values of the example indicated in Table I allow the generation of microdroplets with a stable diameter of about 4.5 μm, i.e. a volume of about 45 fL. Remarkably, the microdroplets 32 are monodisperse and have all the same diameter, approximately equal to the shallow depth h of 4.5 μm. Moreover, the microdroplets 32 are produced at a frequency of between 10.000 drops/sec and 60.000 drops/sec. This geometry enables not only to control de drop volume in a stable way, but also to keep the volume constant over a wide range of sheath fluid and sample fluid flow rates. When the flow rates are modified, the drop production frequency is modified, but the volume thereof remains constant. This is particularly important to allow a good prediction of the number of particles contained in each drop, as indicated hereinabove.

More precisely, the width y and the length z of the fluidic microchannel 24 determine the diameter of the microdroplets 32. For example, the shallow depth h being equal to 4.5 μm, the narrowest width x being equal to 5 μm and the width y being equal to 4 μm, the microdroplets 32 are obtained which have a diameter of between 4 and 5 micrometres, for example 4.5 μm. The depth of the junction zone 7 of the fluidic microchannel 24 and of the expansion zone 8 being in this example of 4.5 μm, the microdroplets 32 are generally almost spherical in shape. The proportional change of the values of length z, width y and depth h allows producing microdroplets with a different diameter. Advantageously, the values of x, y and h are equal: x=y=h. For example, with x=y=h=3 μm, drops of 3 μm in diameter and about 13 fL in volume are obtained, or with x=y=h=6 μm, drops of 100 fL in volume are obtained. The microfluidic chip makes it possible to generate monodisperse microdroplets with a determined volume, of between 1 fL and 200 fL, for example between 10 fL and 100 fL, preferably between 20 fL and 50 fL, even preferably between 30 fL and 40 fL. Respecting this relationship between y, x and h (with certain tolerances, of the order of 20% to 30%) ensures the stability of the flow downstream.

If the length z of the fluidic microchannel 24 is too short, the drops generated have a poorly controlled diameter, usually too large and fluctuating, or are much smaller and irregular: the microdroplets obtained are then polydisperse and not monodisperse. If the length z of the fluidic microchannel 24 is too long, the drops generated have a too great volume, which causes instabilities in the downstream flow and errors in the number of particles per drop.

Certain dimensional parameters of the microfluidic chip are adjusted to allow an easy manufacturing by the photolithography and moulding techniques. The length t of the central nozzle 21 is preferably of 5 μm. If the length t of the central nozzle 21 is too short, the central nozzle 21 may be incorrectly shaped during manufacture. Advantageously, the length t is higher than or equal to the narrowest width x of the central nozzle 21. If the length t of the central nozzle 21 is to long, the central nozzle 21 has a high hydrodynamic resistance likely to slow the advance of the central fluid. To compensate for such a resistance, it would be necessary to increase the central fluid pressure, which may induce damages on the microfluidic chip, for example delamination between the PDMS plate and the glass slide. The length t is here shorter than or equal to 7 μm.

The same constraints as for the length t of the central nozzle 21 apply to the length S of the two lateral nozzles 22, 23.

The expansion zone 8 is a zone in which the linear speed of fluids is reduced, which makes it possible to stabilise the drop formation and prevents drops from being grouped together, either chaotically or in several columns. All along the expansion zone, the drops are accelerated by the viscosity effect of the sheath fluid, for example oil, until reaching a speed almost equal to that of oil. The values of width u and length V of the expansion chamber are therefore relatively tolerant, but there are limits beyond which the flow is no longer stable in a single column. These maximum values are respectively of 50 μm and 500 μm, for example. Once the flow stabilised in the expansion zone 8, another chamfer 39 allows a transition to the fluidic channel 25 and the fluidic channel 27 of the sorting zone 18 of narrower width (e.g. 20 μm). This reduced width of the fluidic channel 27 in the sorting zone 18 allows electrodes 10, 11 to be positioned at small distance from the line of drops 32, which increases the dielectrophoresis effect used for sorting.

The expansion zone 8 advantageously has a chamfer 38 at the inlet (see FIG. 3), which makes it possible to widen the expansion zone from the reduced width r to the widest width u. Advantageously, the expansion zone 8 also has another chamfer 39 towards the downstream (see FIG. 4) that makes it possible to reduce the expansion zone 8 from the widest width u to the width of the fluidic channel 25 at the exit of the expansion zone 8. When using the microfluidic chip, the chamfer(s) encourage fluid flow.

The microdroplets 32 can be detected individually for example by a fluorescence detection system by directing an excitation laser beam to the fluidic channel 25 at the exit of the expansion zone 8 or towards the fluidic channel 27 in the sorting zone 18. At the exit of the zone 8, the narrowing causes an acceleration of the flow by conservation of the flow rate; the drops 32 having a stable diameter, this acceleration has the effect of spacing out the drops, which are better separated for individual analysis and sorting. The lateral channel 9 provides an additional sheath fluid flow rate, which allows the drops to be further spaced apart. In a particularly advantageous way, the detection is made in the fluidic channel 25 or 27 of shallow depth h. For example, an excitation laser beam is directed in a plane transverse to the plane of the microfluidic chip, and a fluorescence signal is detected in this same transverse plane. The shallow depth h is approximately equal to the diameter of the microdroplets, which makes it possible to maintain the order of the drops. Moreover, the shallow depth h also enables to limit the contribution of the sheath fluid to the signal detected. After detection of a microdroplet of interest having a fluorescent marker, this microdroplet can be selectively extracted from the flow in the sorting zone 18 to be oriented towards a determined collecting channel. The detection system generates a signal that triggers the sorting of the so-detected microdroplet. Different sorting devices and methods can be used, for example based on dielectrophoresis, as in the example detailed hereinafter.

In a particularly advantageous manner, the microfluidic chip also comprises a sorting zone 18 integrated on the same support plate. The sorting zone 18 is arranged downstream of the expansion zone 8. The fluidic channel 25 connects for example the expansion zone 8 to the sorting zone 18. The sorting zone 18 comprises a fluidic channel 27 fluidically connected at its entry to the expansion zone 8 via the fluidic channel 25 and at its exit to at least two outlet channels 13, 14, for example via a junction Y denoted 12, whose common branch is the fluidic channel 27. The fluidic channel 25, the fluidic channel 27 and the junction Y towards the two outlet channels have a depth equal to the shallow depth h. In an exemplary embodiment, the two outlet channels 13, 14 have a depth equal to the deep depth H. As an alternative, the two outlet channels 13, 14 have a depth equal to the shallow depth h.

Optionally, a lateral channel 9 is fluidically connected to the inlet of the sorting zone 18 via a nozzle 26. The lateral channel 9 carries a flow of sheath fluid injected via an inlet 19 (see FIG. 1). The lateral channel 9 is adapted to inject a sheath fluid flow on one side of the fluidic channel 27 at the inlet of the sorting zone 18. In an exemplary embodiment, the lateral channel 9 has a depth equal to the deep depth H. As an alternative, the lateral channel 9 has a depth equal to the shallow depth h. The nozzle 26 a depth equal to the shallow depth h.

Advantageously, as illustrated in FIG. 4, the lateral channel 9 includes a filter 6 consisted of studs distributed along sheath fluid paths upstream of the nozzle 26. As indicated hereinabove, such a filter makes it possible to retain any undesirable particles larger than the width of the nozzle 26, likely to block the nozzle 26 and impair its operation.

The lateral channel 9 provides additional sheath fluid to the already-formed train of microdroplets. The lateral channel 9 allows, on the one hand, the spacing between the microdroplets to be changed. Indeed, at the exit of the expansion zone 8, the microdroplets 32 can be relatively close to each other. This makes sorting very difficult, as it requires great precision of action to sort one microdroplet without influencing adjacent microdroplets. The addition of sheath fluid via the side channel 9 increases the spacing between microdroplets to values of several microdroplet diameters, which allows increasing the sorting selectivity.

On the other hand, the lateral channel 9 has for effect to laterally deviate the flow of microdroplets, which is directed by default to one of the two outlet channels, for example the outlet channel 14 that corresponds for example to a bin collecting the drops not selected. The sorting consists in actively individually extracting a selected microdroplet as a function of a signal detected to direct it towards the other outlet channel 13, the microdroplets not selected being passively directed towards the bit outlet.

To a lesser extent, the sheath fluid flow rate in the side channel 9 also influences the production frequency by modifying the hydrodynamic resistance of the fluids circulating in the expansion zone 8.

Advantageously, the sorting zone 18 is a dielectrophoresis sorting zone. For that purpose, the microfluidic chip comprises electrodes 10, 11 arranged on either side of the fluidic channel 27 in the sorting zone 18 (see FIGS. 2 and 4). The channels of the electrodes are formed in the same way as the fluidic channels, with inlets at their ends. These channels are then filled with a conductive material that can be indium injected hot, for example at about 80° C. Other materials can be contemplated to manufacture the electrodes, such as ionic liquid, charged resin or conductive gel.

More precisely, an active electrode 10 is arranged on one side of the fluidic channel 27, a ground electrode 11 is arranged on the same side as the active electrode 10 and another ground electrode 11 is arranged on an opposite side of the fluidic channel 27. The active electrode 10 has a U-shape with the base of the U closest to the fluidic channel 27. The two ground electrodes 11 are advantageously of symmetrical shape with respect to the longitudinal direction of the fluidic channel 27 of the sorting zone 18. Each ground electrode 11 has a M-shape, with the points of the M arranged at the closest to the fluidic channel 27. The U-shaped active electrode 10 is arranged between the two points of the M-shaped ground electrode 11. The minimum distance between each of the electrodes 10, 11 and the fluidic channel 27 is between 5 μm and 40 μm, for example here of about 10 μm. The active electrode 10 is at the minimum distance from the fluidic channel 27, approximately at the middle of the sorting zone 18 in the fluid flow direction. Each of the two ground electrodes 11 is at the minimum distance of the fluidic channel 27 towards the entry of the sorting zone 18, for example just downstream of the nozzle 26 of the lateral channel 9. Each of the two ground electrodes 11 is also at the minimum distance of the fluidic channel 27 towards the exit of the sorting zone 18, upstream of the junction 12 between the two outlet channels 13, 14. On the other hand, at the middle of the sorting zone 18, the two ground electrodes 11 move away from the fluidic channel 27, so as to avoid interfering with the active electrode 10. That way, the two ground electrodes 11 surround the active electrode 10 in the plane of the microfluidic device and limit the spatial extension of the electric field gradient upstream and downstream of the sorting zone 18. The active electrode 10 is surrounded by the fluidic channel 27 and by one of the ground electrodes 11.

The arrangement of the electrodes 10, 11 enables both to maximise the electric field gradient on the central zone of the fluidic channel 27 in the middle of the sorting zone 18, and to spatially confine the electric field gradient in the central zone in which is located the microdroplet to be sorted. The two ground electrodes 11 limit the spatial extension of the electric field gradient upstream of the sorting zone 18, where this field gradient is likely to influence the next microdroplet. The two ground electrodes 11 limit the spatial extension of the electric field gradient downstream of the sorting zone 18, where this field gradient is likely to influence the already sorted microdroplets that are in a wider and deeper zone and to therefore avoid the merging of several already-sorted microdroplets.

The arrangement of the electrodes 10, 11 enables the electric field to be more effective, particularly as the fluidic channel 27 has a reduced width, e.g. a width of 20 μm, with respect to the expansion zone 8. Indeed, the dielectrophoresis effect is all the more effective and spatially constrained the closer the drops 32 are to the electrodes 10, 11. Therefore, electrodes are placed as close as technologically possible to the fluidic channel 27. For example, the distance between the electrodes and the fluidic channel 27 is of 10 μm, the channel has a width of 20 μm and the drops 32 circulate in the middle of the fluidic channel 27. The distance between the electrodes 10, 11 and the drops 32 is in this example of about 20 μm.

The sorting method comprises the application of a high-voltage electric pulse, e.g. between 500 V and 1000 V peak (or 1000 V and 2000 V peak to peak for alternating signals), and of short duration T at the active electrode 10. The duration T is for example between 10 μs and 200 μs; it may be a positive pulse, a negative pulse, a period of a sinusoid or square or any zero-mean waveform, or several periods of sinusoids, squares or zero-mean waveforms. This pulse may be of continuous voltage. Preferably, this pulse is of alternating voltage, at a chosen electric frequency f, on the one hand, so that the pulse duration T is equal to one or several periods of the alternating frequency 1/f, so as to avoid polarising the content of the fluidic channel 27 in the sorting zone 18. And on the other hand, the duration of the electrical pulse is chosen shorter than, or equal to or slightly higher than, the time between the passage of two successive microdroplets 32 in the sorting zone 18 in order to ensure the extraction of a single microdroplet 32. The electrical frequency range f is, for example, between 20 kHz and 200 kHz and the range of durations T between 10 μs and 50 μs, to enable sorting at a drop frequency of between 10 kHz and 50 kHz.

The electrodes 10, 11 create a spatially variable electric field (field gradient) that acts on a microdroplet by means of a force generated by a dielectrophoresis effect. The application of an electrical pulse on a microdroplet deviates the microdroplet to direct it selectively towards one of the two outlet channels 13. On the contrary, in the absence of electric pulse, a microdroplet is directed towards the other one of the two outlet channels 14. The fractions sorted in the two in the two outlet channels 13, 14 can be collected in distinct collectors connected to the outlets 16 and 17, respectively.

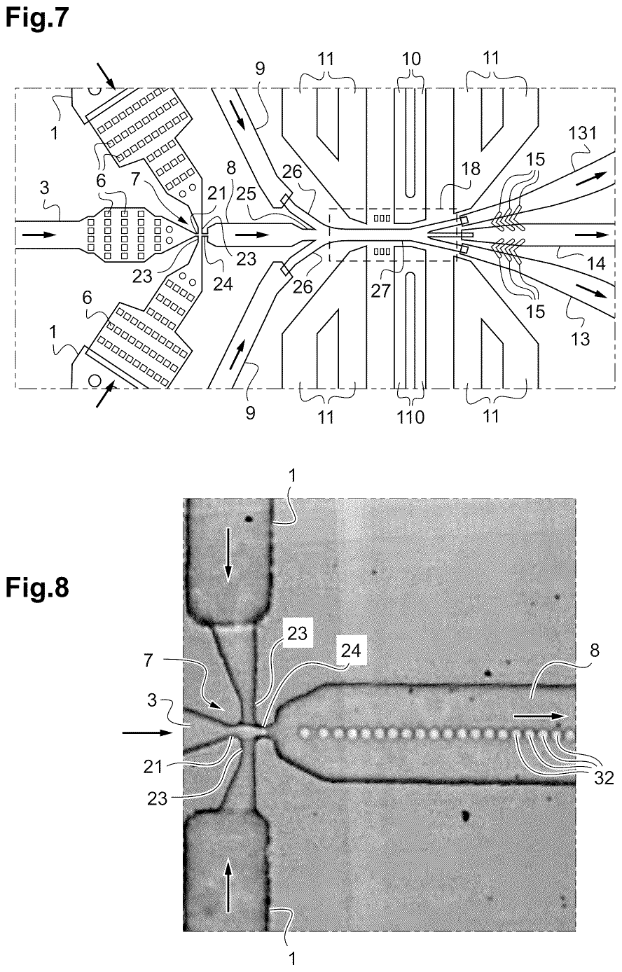

As an alternative, the microfluidic chip with two outlet channels 13, 14 can have two active electrodes 10 arranged symmetrically on either side of the fluidic channel 27, as illustrated in FIG. 7. By way of example, the two active electrodes 10 can be controlled alternately: one of the electrodes being used to direct a microdroplet 32 towards the outlet 14 (bin) and the other electrode 10 being used to direct another microdroplet 32 towards the collection channel 13. Moreover, the two active electrodes 10 can be controlled simultaneously with different voltages, so as to reduce the voltage required to obtain the dielectrophoresis effect.

According to the present disclosure, continuously along the fluidic path of the microdroplets 32 from the microdroplet formation zone 29 to the sorting zone 18 included, all the channels and all the zones have a depth equal to the shallow depth h, which determines the diameter of the microdroplets, of 4.5 μm in the example of Table I. The junction zone 7, including the inlet nozzles 21, 22, 23, the fluidic microchannel 24, the expansion zone 8, the fluidic channel 25, the nozzle 26 and the sorting zone 18, including the fluidic channel 27 and the Y junction 12, have a depth equal to the shallow depth h. In a particular embodiment, the microfluidic chip includes channels or zones having two distinct depths. In this embodiment, the sheath fluid injection channels 1 and 9 and the outlet channels 13, 14 are deeper (depth H ~10 μm in the same example), these zones being not critical to the production, the detection and the sorting of microdroplets.

For example, in FIG. 2, the zones 3, 4, 5, 7 and 8 are the zones of shallow depth h ~4.5 μm. Between the connection of the central fluid injection channel 3 and the nozzle 21, the linear speed of the fluid is determined by the volume flow rate divided by the channel cross-section. Choosing at this place a shallow depth of channel (4.5 μm) ensures a higher linear speed, and prevents that way particles carried by the central fluid from settling. On the other hand, from the nozzle 21 to the exit of the sorting zone 18, the shallow depth h enables to maintain the microdroplet volume and to guarantee that the microdroplets produced and detected in a certain order arrive in the same order in the sorting zone 18. The other zones 1, 2, 9, 19, 13, 14, 16, 17, can have a deep depth H of 10 μm, for reducing fluid flow constraints and therefore the pressure required.

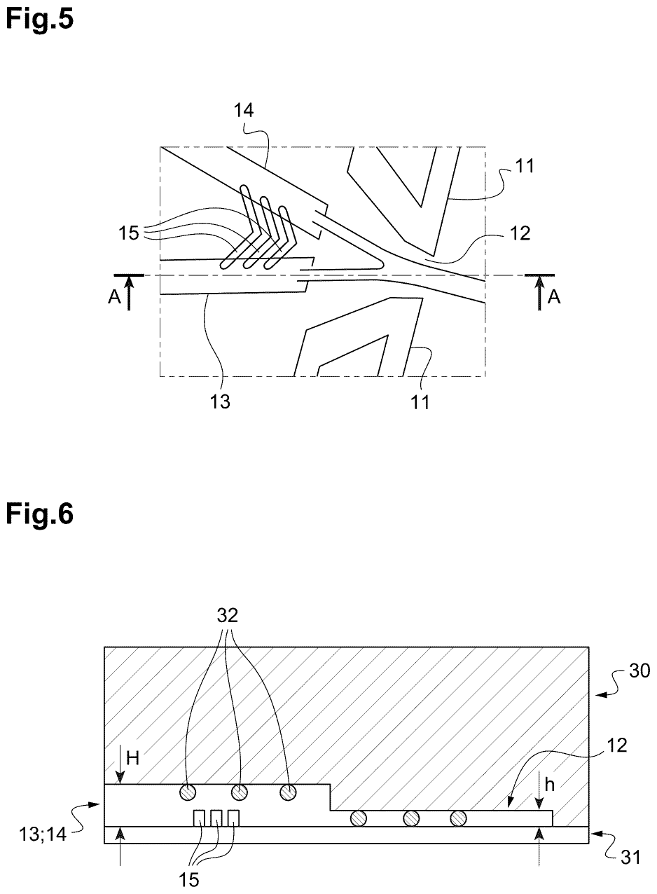

Advantageously, the microfluidic chip comprises one or several balancing microchannel 15 fluidically connecting one of the two outlet channels 13 to the other one of the outlet channels 14. The microchannel(s) 15 makes it possible to equilibrate the pressure between the two outlet channels 14, that may have different flow rates, linked to different pressures, likely to impair the sorting efficiency. The balancing microchannels 15 have a depth equal to the shallow depth h, e.g. 4.5 μm, and a narrow width of the order of 5 μm. These dimensions makes it possible to avoid the passage of sorted microdroplets between the two outlet channels 14, via one of the balancing microchannels 15 (see FIGS. 5-6). By way of non-limiting example, the microdroplets are based on water and the sheath fluid is based on an oil used in microfluidics. The microfluidic chip is arranged horizontally, the balancing microchannels 15 of shallow depth being oriented towards the bottom of the chip, so that the microdroplets 32, which are lighter than oil, rise rapidly to the top of the outlet channel 13, or 14, of deep depth H, for example equal to 10 μm. Therefore, the microdroplets 32 having a diameter of 4.5 μm are unlikely to be captured by the balancing microchannels 15 located below.

FIG. 7 shows a microfluidic chip according to an alternative embodiment of the microfluidic chip described in relation with FIGS. 1 to 6. In this alternative, the sorting zone 18 includes three outlet channels. The outlet channel 14 is arranged at the centre and corresponds to the bin channel. Two outlet channels 13, 131 or collection arms are arranged laterally, for example symmetrically with respect to the outlet channel 14, to allow a sorting according to two distinct criteria. Advantageously, two lateral channels 9 are fluidically connected via a nozzle 26 to the inlet of the sorting zone 18, on the two opposite sides of the fluidic channel 27. Each lateral channel 9 carries a sheath fluid flow. Each lateral channel 9 is adapted to inject a sheath fluid flow on one side of the fluidic channel 27 of the sorting zone 18. In an embodiment, each lateral channel 9 has a depth equal to the deep depth H. Moreover, the system of electrodes here includes two active electrodes 10, 110 and the ground electrodes 11. A U-shaped active electrode 10 or 110 and an M-shaped ground electrode 11 are arranged on either side of the fluidic channel 27, symmetrically with respect to the longitudinal direction of the fluidic channel 27. Each of the two active electrodes 10, 110 is at a minimum distance from the fluidic channel 27 comprised between 5 μm and 40 μm, for example about 10 μm. Preferably, the points of the M of each ground electrode 11 are arranged as close as possible to the fluidic channel 27, for example at a minimum distance of between 5 μm and 40 μm, for example about 10 μm. Each active electrode 10, 110 is surrounded by the fluidic channel 27 and by one of the ground electrodes 11. In the absence of electrical voltage on the active electrodes 10 and 110, all the drops 32 are sent into the outlet channel 14. The application of an electrical pulse to one of the two electrodes 10 or 110 has for effect to deviate a drop 32 propagate in the sorting zone 18 between the two electrodes 10 and 110 towards one of the two outlet channels 13 or 131.

The configuration illustrated in FIG. 7 has several advantages. First, it provides a greater symmetry of the flow, which improves the stability. Indeed, the splitting of the lateral channel 9 into two lateral channels located on either side of the central fluidic channel 27 has the effect of making the supply of sheath fluid symmetrical, which is then used solely to control the spacing of drops 32. Finally, an electrode 10, 110 is arranged so as to direct selectively the drops towards one or the other of the outlet arms 13, 131. This configuration makes it possible to separate and collect two different populations of sorted drops in two different collection arms 13 and 131, respectively. On the contrary, the device of FIG. 4 includes a single active electrode to direct the selected drops towards a single collection arm 13.

In summary, the drop creation zone of the microfluidic chip comprises a fluidic microchannel 24 at the exit of the junction zone 7, the fluidic microchannel 24 having such dimensions than y~h approximately, and z≥y and h. The central fluid constriction zone (for example, an aqueous fluid) in the sheath fluid flow (for example, an oily fluid) are such that x~x1~y. The expansion zone 8 has a width u of about 50 μm and a length V of about 500 μm. The outlet of the expansion zone 8 connected to the fluidic channel 25 narrows to a width of about 20 μm in the measuring and sorting zone 18. In a particular embodiment, the microfluidic chip includes channels and zones having two distinct depths: a shallow depth h, continuously on the fluidic path of the microdroplets 32 from the microdroplet formation zone 29 to the sorting zone 18 included, and a deep depth H out of the zones critical to the production, detection and sorting of microdroplets, such as in particular the sheath fluid injection channels and the outlet channels. In the sorting zone 18, the active electrodes 10, 110 are arranged as close as possible to the fluidic channel 27, for example at a distance of about 10 μm. The use of ground electrodes 11 on either side of the active electrodes 10, 110 makes it possible to limit the spatial extension of the electric field in the longitudinal direction of the fluidic channel 27 in the sorting zone 18.

The microfluidic device and method of the present disclosure make it possible to select and sort the drops that contain a nanoparticle detected, for example by fluorometry, and to direct only the drops containing the desired type of nanoparticle towards a determined outlet. The microfluidic device and method make it possible to collect on this outlet only the drops containing the desired type of nanoparticles, except the empty drops and the drops containing other types of nanoparticles. The microfluidic device and method thus make it possible to concentrate the desired nanoparticles in the collected fluid.

The integration on a same microfluidic chip of a monodisperse microdroplet production zone, an expansion zone, a detection and sorting zone, at short distance from each other enables both to generate monodisperse microdroplets of small volume, between 1 fL and 200 fL, at high frequency (e.g. several tens of kHz) and to actively and individually sort each microdroplet, with a high efficiency and also with a high sorting frequency. The expansion zone makes it possible to maintain the drops ordered in a single column up to the detection and sorting zone. Such a configuration makes it possible to avoid the intermediate storing and the transportation of microdroplets from a microdroplet generation device to another sorting device. This configuration makes it possible to avoid that the microdroplets stick to each other or to the wall of a storage container. In total, the generation and sorting of microdroplets are both faster and more reliable.

The present disclosure finds applications for the generation of monodisperse microdroplets of volume between 1 fL and 200 fL containing chemical or biological particles of nanometric size. Moreover, the present disclosure finds applications in the sorting of so-generated microdroplets without dilution, by detecting a signal associated with a property of the chemical or biological particle of nanometric dimensions, and triggering sorting as a function of the signal detected. In particular, the present disclosure finds applications in the generation and sorting of monodisperse microdroplets containing nano-objects with a concentration up to 10⁹ à 10¹⁰ nano-objects per millilitre, such as for example extracellular vesicles or cell secretions, in particular exosomes, but also viral vectors or also large individual molecules. The disclosed microfluidic chip enables fluorescent nanoparticles to be encapsulated and sorted as a function of the measured fluorescence. The disclosed microfluidic chip also enables organic particles marked by fluorescence to be measured and sorted by being encapsulated in drops. The present disclosure also finds other applications in chemistry, for example for the purification of nanometric probes, or in granulometry of nanometric objects. Moreover, the microfluidic chip integrates the functions of generation and sorting of drops without intermediate storage, which not only enable generating drops at high frequency but also individual sorting of drops, on the fly, just after the generation thereof, and at high frequency, for example from a few kHz to more than 100 kHz.

1. A microfluidic chip (30) for generating and sorting monodisperse microdroplets (32) based on a central fluid in a sheath fluid, the central fluid and the sheath fluid being immiscible with each other, wherein: the microfluidic chip (30) comprises a central fluid injection channel (3), two sheath fluid injection channels (1) and in that the microfluidic chip (30) comprises a junction zone (7), an expansion zone (8) downstream of the junction zone (7) and a sorting zone (18) arranged downstream of the expansion zone (8), a fluidic microchannel (24) fluidically connecting the junction zone (7) to the expansion zone (8), the sorting zone (18) comprising a fluidic channel (27) fluidically connected, at its inlet, to the expansion zone (8) and, downstream, to at least two outlet channels (13, 131, 14), the junction zone (7) comprising a central nozzle (21) fluidically connected to the central fluid injection channel (3), two lateral nozzles (22, 23) arranged on two opposite sides of the junction zone (7), each of the two lateral nozzles (22, 23) being fluidically connected to one of the two sheath fluid injection channels (1), the fluidic microchannel (24) being arranged on an opposite face of the junction zone (7) with respect to the central nozzle (21), the central nozzle (21) having a narrowest width x of between 2 and 10 micrometres, each of the two lateral nozzles (22, 23) having a narrowest width x1 of between 3 and 10 micrometres, the fluidic microchannel (24) having a width y of between 2 and 7 micrometres, and a length z of between 2 and 10 micrometres, the expansion zone (8) having a widest width u of between 20 and 75 micrometres and the expansion zone (8) having a length V of between 100 and 600 micrometres, and in that the junction zone (7), the fluidic microchannel (24), the expansion zone (8) and the fluidic channel (27) of the sorting zone (18) have a depth h of between 2 micrometres and 10 micrometres, the microfluidic chip being capable of generating, via the fluidic microchannel (24), monodisperse microdroplets (32) having a determined volume of between 1 femtolitre and 200 femtolitres.

2. The microfluidic chip according to claim 1, wherein the sorting zone (18) comprises an active electrode (10) arranged on one side of the fluidic channel (27) and two ground electrodes (11) arranged on either side of the fluidic channel (27), the two ground electrodes (11) surrounding the active electrode (10) in the sorting zone (18) around the fluidic channel (27), the active electrode (10) being at a minimum distance from the fluidic channel (27) of between 5 μm and 40 μm.

3. The microfluidic chip according to claim 1, wherein the sorting zone (18) comprises two active electrodes (10, 110) and two ground electrodes (11), the two active electrodes (10, 110) being arranged on two opposite sides of the fluidic channel (27), the two ground electrodes (11) being arranged on two opposite sides of the fluidic channel (27), each of the two ground electrodes (11) surrounding one of the two active electrodes (10, 110) in the sorting zone (18) around the fluidic channel (27), each of the two active electrodes (10, 110) being at a minimum distance from the fluidic channel (27) of between 5 μm and 40 μm.

4. The microfluidic chip according to claim 1, comprising at least one lateral channel (9) fluidically connected to the inlet of the sorting zone (18), the at least one lateral channel (9) being adapted to inject a sheath fluid flow.

5. The microfluidic chip according to claim 1, wherein the expansion zone (8) has at the exit of the fluidic microchannel (24) a reduced width r of between 5 and 15 micrometres, and the expansion zone (8) widens downstream from the reduced width r to the widest width u.

6. The microfluidic chip according to claim 1, wherein the expansion zone (8) is connected to the fluidic channel (27) of the sorting zone (18) by a fluidic channel (25) having a depth equal to the shallow depth h and a width of about 20 μm, the width of the expansion zone (8) narrowing downstream from the widest width u to the width of about 20 μm of the fluidic channel (25).

7. The microfluidic chip according to claim 1, wherein the central fluid injection channel (3), the two sheath fluid injection channels (1) and the at least two outlet channels (13, 131, 14) have a depth equal to the depth h.

8. The microfluidic chip according to claim 1, wherein the central fluid injection channel (3), the two sheath fluid injection channels (1) and the at least two outlet channels (13, 131, 14) have a depth H deeper than the depth h of the junction zone (7), the depth H being between 6 micrometres and 20 micrometres.

9. The microfluidic chip according to claim 1, comprising a device based on micro-pumps or syringe pumps adapted to inject the sheath fluid and the central fluid respectively into the microfluidic chip.

10. A method for generating and sorting monodisperse microdroplets by means of a microfluidic chip according to claim 1, comprising the following steps:
simultaneously injecting a central fluid into the central fluid injection channel (3) towards the junction zone (7) of the microfluidic chip and a sheath fluid into the two sheath fluid injection channels towards the junction zone (7);
generating monodisperse microdroplets (32) of central fluid within the sheath fluid in the fluidic microchannel (24) fluidically connecting the junction zone (7) to the expansion zone (8) of the microfluidic chip, the microdroplets having a determined volume, of between 1 femtolitre and 200 femtolitres, and
propagating the microdroplets in an ordered manner towards a sorting zone of the microfluidic chip so as to actively and individually sort each microdroplet.

11. The microfluidic chip according to claim 2, comprising at least one lateral channel fluidically connected to the inlet of the sorting zone, the at least one lateral channel being adapted to inject a sheath fluid flow.

12. The microfluidic chip according to claim 3, comprising at least one lateral channel fluidically connected to the inlet of the sorting zone, the at least one lateral channel being adapted to inject a sheath fluid flow.

13. The microfluidic chip according to claim 2, wherein the expansion zone has at the exit of the fluidic microchannel a reduced width r of between 5 and 15 micrometres, and the expansion zone widens downstream from the reduced width r to the widest width u.

14. The microfluidic chip according to claim 3, wherein the expansion zone has at the exit of the fluidic microchannel a reduced width r of between 5 and 15 micrometres, and the expansion zone widens downstream from the reduced width r to the widest width u.

15. The microfluidic chip according to claim 2, wherein the expansion zone is connected to the fluidic channel of the sorting zone by a fluidic channel having a depth equal to the shallow depth h and a width of about 20 μm, the width of the expansion zone narrowing downstream from the widest width u to the width of about 20 μm of the fluidic channel.

16. The microfluidic chip according to claim 3, wherein the expansion zone is connected to the fluidic channel of the sorting zone by a fluidic channel having a depth equal to the shallow depth h and a width of about 20 μm, the width of the expansion zone narrowing downstream from the widest width u to the width of about 20 μm of the fluidic channel.

17. The microfluidic chip according to claim 2, wherein the central fluid injection channel, the two sheath fluid injection channels and the at least two outlet channels have a depth equal to the depth h.

18. The microfluidic chip according to claim 3, wherein the central fluid injection channel, the two sheath fluid injection channels and the at least two outlet channels have a depth equal to the depth h.

19. The microfluidic chip according to claim 2, wherein the central fluid injection channel, the two sheath fluid injection channels and the at least two outlet channels have a depth H deeper than the depth h of the junction zone, the depth H being between 6 micrometres and 20 micrometres.

20. The microfluidic chip according to claim 3, wherein the central fluid injection channel, the two sheath fluid injection channels and the at least two outlet channels have a depth H deeper than the depth h of the junction zone, the depth H being between 6 micrometres and 20 micrometres.
